(19) United States
(12) Patent Application Publication
(10) Pub. No.: US 2025/0271563 A1
(43) Pub. Date: Aug. 28, 2025

(54) METHODS OF LOCATING A TARGET OBJECT IN A RANGING DEVICE, AND RANGING DEVICES THEREOF

(71) Applicant: Asia Optical Co., Inc., Taichung (TW)

(72) Inventors: Hua-Tang Liu, Taichung (TW); Sheng Luo, ShenZhen City (CN); Han Lu, ShenZhen City (CN); Peng-Fei Song, ShenZhen City (CN); Yang-Yang Yu, ShenZhen City (CN)

(21) Appl. No.: 18/967,702

(22) Filed: Dec. 4, 2024

(30) Foreign Application Priority Data
Feb. 28, 2024 (CN) 202410225355.4

(51) Int. Cl. G01S 7/51; G01S 17/08

(52) U.S. Cl. CPC G01S 7/51; G01S 17/08

(57) ABSTRACT

Methods of locating a target object in a ranging device and the ranging devices thereof are provided. First, a signal processor is used to process a first signal of a first signal module corresponding to a first target object, where the first signal at least includes location information. Then, a first target distance corresponding to the first target object is determined based on a device location of the ranging device and the location information in the first signal. After that, a laser ranging unit is used to perform a ranging operation on the first target object to obtain a first laser ranging result, and a display unit is used to display a first icon corresponding to the first target object according to the first target distance or the first laser ranging result.

### BACKGROUND OF THE INVENTION

### Field of the Invention

The disclosure relates generally to ranging methods and ranging devices, and, more particularly to methods and devices that can locate and display target objects in the ranging devices, and further perform ranging operations to increase accuracy.

### Description of the Related Art

Recently, laser rangefinders have replaced traditional ranging methods and become the mainstream of ranging systems. Laser ranging can be classified into three methods: triangulation, time measurement, and confocal measurement. The most commonly used method at present is the time measurement method, which is to measure the time of laser round trip (Time of Flight, ToF). The principle of ToF is to use an aiming device or a rangefinder to emit coded laser light from a pulsed infrared light source to the target. The ToF camera is responsible for receiving the laser reflected from the target and calculating the distance to the target based on the ranging formula. Due to the unique principle of laser, even if the target is inconvenient to approach, it can still be measured through the instrument.

The operation of traditional laser aiming devices or laser rangefinders is simply to emit several laser beams at the target through the transmitter. If the number of laser reflections received by the receiver is greater than the threshold, for example, 60% of the number of laser reflections is received, the ToF value of those successfully received laser reflections can be calculated and the final distance can be calculated as the output result. However, in some special application scenarios, such as in the outdoor hunting and golf markets, rangefinders only provide functions such as distance and angle measurement, and different segment displays. The function and application of the rangefinder is relatively simple.

In these application scenarios, if one or more target objects, such as partners, hounds, golf holes, etc. can be located and tracked, users will be able to better control the location and status of themselves and specific target objects, so as to have a more comprehensive understanding of the current status of the application execution and take necessary feedback in real time.

### BRIEF SUMMARY OF THE INVENTION

In an embodiment of a method of locating a target object in a ranging device, a signal processor is used to process a first signal of a first signal module corresponding to a first target object, where the first signal at least includes location information. Then, a first target distance corresponding to the first target object is determined based on a device location of the ranging device and the location information in the first signal. After that, a laser ranging unit is used to perform a ranging operation on the first target object to obtain a first laser ranging result, and a display unit is used to display a first icon corresponding to the first target object according to the first target distance or the first laser ranging result.

An embodiment of a ranging device includes a laser ranging unit, a signal processor, a display unit, and a processing unit. The signal processor processes a first signal of a first signal module corresponding to a first target object, wherein the first signal at least comprises location information. The processing unit coupled to the signal processor and the display unit, and determines a first target distance corresponding to the first target object based on a device location of the ranging device and the location information in the first signal. The processing unit performs a ranging operation on the first target object by using the laser ranging unit to obtain a first laser ranging result, and displays a first icon corresponding to the first target object according to the first target distance or the first laser ranging result through the display unit.

In some embodiments, the signal processor further continuously processes a plurality of signals of the first signal module corresponding to the first target object, and the processing unit further calculates a moving trajectory corresponding to the first target object based on the signals, and displays the moving trajectory corresponding to the first target object through the display unit.

In some embodiments, the processing unit further determines whether a strength of the first signal is lower than a threshold value, and displays a notification through the display unit to remind that the first signal corresponding to the first target object is about to be lost when the strength of the first signal is lower than the threshold value.

In some embodiments, the processing unit further obtains map data, wherein a dangerous terrain area is defined in the map data, and displays a prompt corresponding to the dangerous terrain area based on the map data, the device location corresponding to the ranging device, or the location information in the first signal through the display unit.

In some embodiments, the processing unit further corrects the first target distance based on the first laser ranging result.

In some embodiments, the signal processor determines a first relative position corresponding to the first target object based on a GPS (Global Positioning System) technology, a Wi-Fi positioning technology, or a UWB (Ultra Wideband) positioning technology.

In some embodiments, the signal processor wirelessly receives the first signal transmitted by the first signal module corresponding to the first target object, wherein the technology for receiving or transmitting the first signal is Bluetooth technology or Wi-Fi technology, in which a signal receiver is activated by a signal transmitting module, or the signal transmitting module is activated by the signal receiver.

In some embodiments, the signal processor further processes a second signal corresponding to a second signal module corresponding to a second target object, wherein the second signal at least comprises location information, the processing unit further determines a second target distance corresponding to the second target object based on the device location of the ranging device and the location information in the second signal, the laser ranging unit further performs the ranging operation on the second target object to obtain a second laser ranging result, and the processing unit correcting the first target distance based on the second target distance or the second laser ranging result.

In some embodiments, the signal processor further processes a second signal corresponding to a second signal module corresponding to a second target object, wherein the second signal at least comprises location information, and the processing unit determines a second target distance corresponding to the second target object based on the device location of the ranging device and the location information in the second signal, and displays a second icon corresponding to the second target object and the corresponding second target distance based on a second relative position through the display unit.

In some embodiments, the display unit comprises a high-resolution dot matrix OLED (Organic Light-Emitting Diode) or a micro OLED.

Methods of locating a target object in a ranging device may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a ranging device of the invention;

FIG. 2 is a schematic diagram illustrating another embodiment of a ranging device of the invention;

FIG. 3 is a schematic diagram illustrating an embodiment of a laser ranging unit of the invention;

FIG. 4 is a flowchart of an embodiment of a method of locating a target object in a ranging device of the invention;

FIG. 5 is a flowchart of another embodiment of a method of locating a target object in a ranging device of the invention;

FIG. 6 is a flowchart of an embodiment of a method of correcting a target object distance of the invention;

FIG. 7 is a flowchart of another embodiment of a method of locating a target object in a ranging device of the invention;

FIG. 8 is a flowchart of another embodiment of a method of locating a target object in a ranging device of the invention;

FIG. 9 is a flowchart of another embodiment of a method of locating a target object in a ranging device of the invention;

FIG. 10 is a flowchart of another embodiment of a method of locating a target object in a ranging device of the invention;

FIG. 11 is an example of locating a target object in a ranging device of the invention;

FIG. 12 is a schematic diagram illustrating a screen displayed on a display unit in the example of FIG. 11;

FIG. 13 is a schematic diagram illustrating a screen with a moving trajectory corresponding to the target object in the example of FIG. 11;

FIG. 14 is an example of locating several target objects in a ranging device of the invention; and

FIG. 15 is a schematic diagram illustrating a screen displayed on a display unit in the example of FIG. 14.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

FIG. 1 is a schematic diagram illustrating an embodiment of a ranging device of the invention. The ranging device 100 according to the embodiment of the present invention at least includes a signal receiver 110, a display unit 120, and a processing unit 130 electrically coupled to the signal receiver 110 and the display unit 120. The signal receiver 110 can wirelessly receive a signal transmitted from a signal transmitting module. It should be noted that the aforementioned signal receiver 110 can be a signal processor in the ranging device, which can process a signal corresponding to a signal module. It is noted that in some embodiments, the signal transmitting module can be set on a target object, and use the GPS technology, Wi-Fi technology, and/or UWB positioning technology to send at least one signal with location information. It should be noted that the signal receiver 110 can receive signals using technologies corresponding to the signal transmitting module. The aforementioned technologies that can be used to receive signals include, but are not limited to, Bluetooth technology, Wi-Fi technology and other communication technologies. The signal receiver 110 needs to be paired or adapted with the signal transmitting module first, so that the signal receiver 110 can correspondingly and actively or passively receive the signal actively or passively generated by the signal transmitting module. It is understood that, the active or passive behavior means including but not limited to the signal receiver 110 being activated by the signal transmitting module, or the signal transmitting module being activated by the signal receiver 110, so that the signal receiver 110 and the signal transmitting module can send and receive communications to each other. The display unit 120 can display relevant data, the details of which will be described later. In some embodiments, the display unit 120 may be a high-resolution dot matrix OLED or a micro OLED. The processing unit 130 may be a general-purpose computing unit used to perform the methods of locating a target object in the ranging device of the invention, the details of which will be described later.

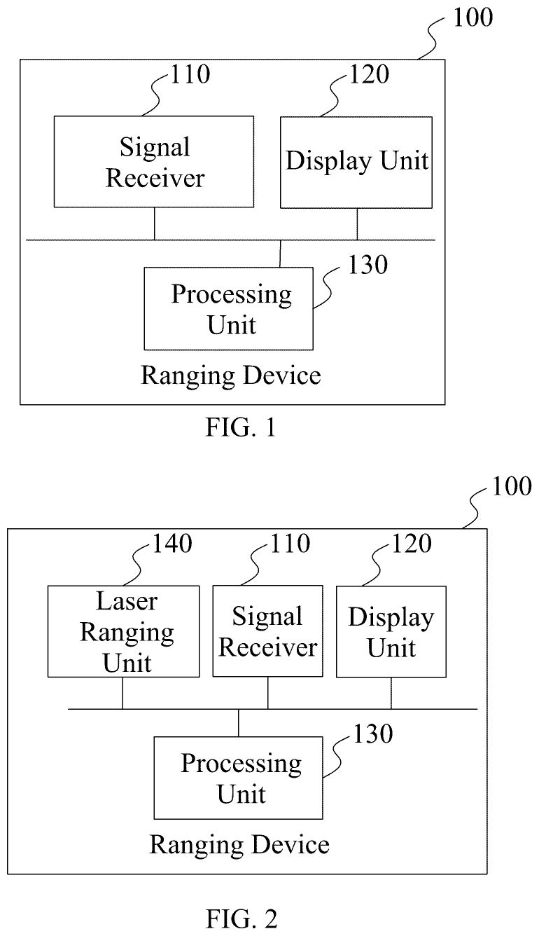

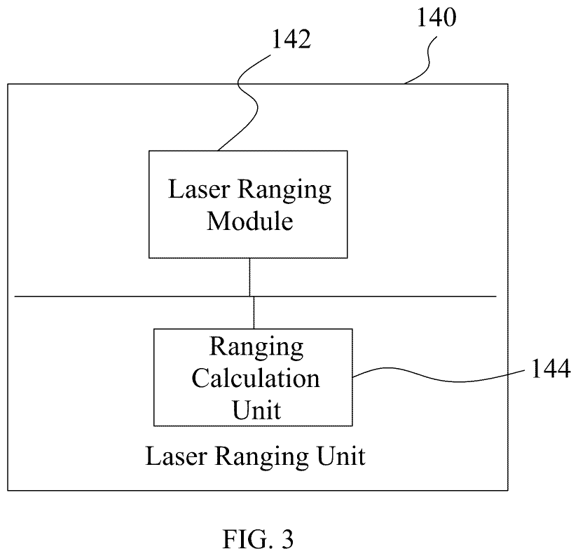

FIG. 2 is a schematic diagram illustrating another embodiment of a ranging device of the invention. The ranging device 100 according to the embodiment of the present invention at least includes a laser ranging unit 140, a signal receiver 110, a display unit 120, and a processing unit 130 electrically coupled to the laser ranging unit 140, the signal receiver 110 and the display unit 120. The laser ranging unit 140 is used to measure the distance of a corresponding target object to obtain the distance between the target object and the ranging device 100. FIG. 3 is a schematic diagram illustrating an embodiment of a laser ranging unit of the invention. The laser ranging unit 140 according to the embodiment of the invention includes a laser ranging module 142 and a ranging calculation unit 144. The laser ranging module 142 can emit a laser light toward a target object and receive the reflected laser light. The ranging calculation unit 144 can calculate the distance between the ranging device 100 and the target object using a ranging formula based on the time of emitting laser light and the time of receiving reflected laser light. Similarly, the signal receiver 110 can wirelessly receive a signal transmitted from a signal transmitting module. Similarly, the aforementioned signal receiver 110 can be a signal processor in the ranging device, which can process the signal corresponding to a signal module. It is noted that in some embodiments, the signal transmitting module can be set on a target object, and use the GPS technology, Wi-Fi technology, and/or UWB positioning technology to send at least one signal with location information. Similarly, the signal receiver 110 can receive signals using technologies corresponding to the signal transmitting module. The aforementioned technologies that can be used to receive signals include, but are not limited to, Bluetooth technology, Wi-Fi technology and other communication technologies. The signal receiver 110 needs to be paired or adapted with the signal transmitting module first, so that the signal receiver 110 can correspondingly and actively or passively receive the signal actively or passively generated by the signal transmitting module. The active or passive behavior means including but not limited to the signal receiver 110 being activated by the signal transmitting module, or the signal transmitting module being activated by the signal receiver 110, so that the signal receiver 110 and the signal transmitting module can send and receive communications to each other. The display unit 120 can display relevant data, the details of which will be described later. In some embodiments, the display unit 120 may be a high-resolution dot matrix OLED or a micro OLED. The processing unit 130 may be a general-purpose computing unit used to perform the methods of locating a target object in the ranging device of the invention, the details of which will be described later.

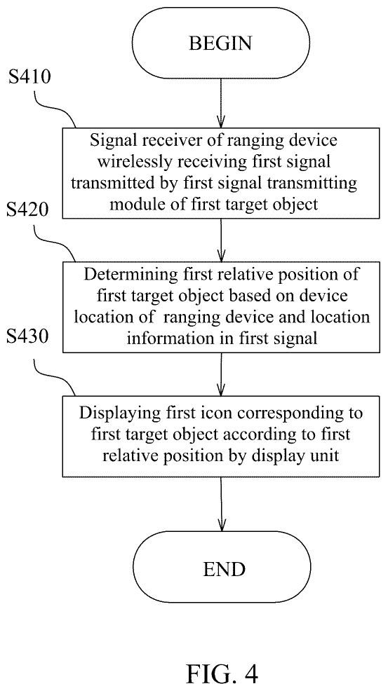

FIG. 4 is a flowchart of an embodiment of a method of locating a target object in a ranging device of the invention. The method of locating a target in a distance measuring device according to the embodiment of the present invention is applicable to the ranging device as shown in FIG. 1 or FIG. 2.

In step S410, a signal receiver of the ranging device is used to wirelessly receive a first signal transmitted by a first signal transmitting module corresponding to a first target object. As mentioned above, the signal transmitting module can be set on a target object and use the GPS technology, the Wi-Fi technology, and/or the UWB positioning technology to send signals with location information. In step S420, a first relative position corresponding to the first target object is determined based on a device location of the corresponding ranging device and the location information in the first signal. It should be noted that in some embodiments, the processing unit of the ranging device may also determine the first relative position corresponding to the first target object based on the GPS technology, the Wi-Fi positioning technology, or the UWB positioning technology. Then, in step S430, a display unit of the ranging device is used to display a first icon corresponding to the first target object according to the first relative position.

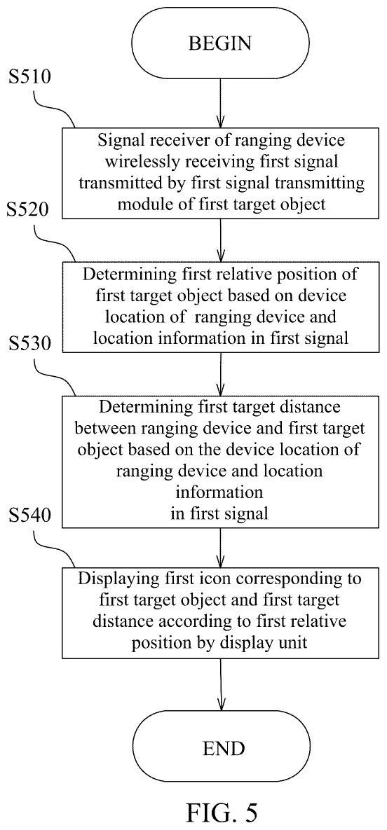

FIG. 5 is a flowchart of another embodiment of a method of locating a target object in a ranging device of the invention. The method of locating a target in a distance measuring device according to the embodiment of the present invention is applicable to the ranging device as shown in FIG. 1 or FIG. 2.

In step S510, a signal receiver of the ranging device is used to wirelessly receive a first signal transmitted by a first signal transmitting module corresponding to a first target object. As mentioned above, the signal transmitting module can be set on a target object and use the GPS technology, the Wi-Fi technology, and/or the UWB positioning technology to send signals with location information. In step S520, a first relative position corresponding to the first target object is determined based on a device location of the corresponding ranging device and the location information in the first signal. Similarly, in some embodiments, the processing unit of the ranging device may also determine the first relative position corresponding to the first target object based on the GPS technology, the Wi-Fi positioning technology, or the UWB positioning technology. Then, in step S530, a first target distance between the ranging device and the first target object is determined based on the device location of the corresponding ranging device and the location information in the first signal. In other words, in some embodiments, the first target distance corresponding to the first target object can be determined based on the device location of the corresponding ranging device and the location information in the first signal. Then, in step S540, a display unit of the ranging device is used to display a first icon corresponding to the first target object and the first target distance corresponding to the first target object according to the first relative position.

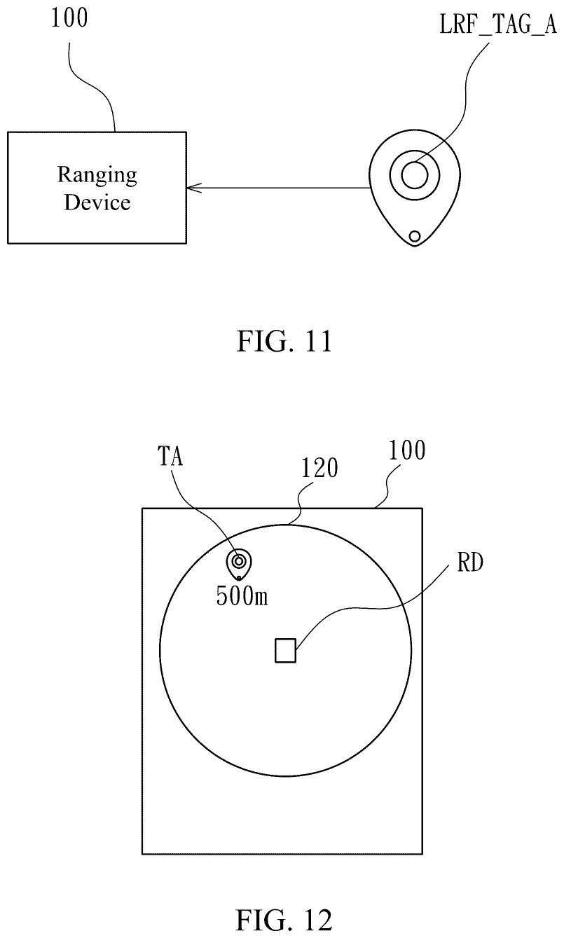

FIG. 11 is an example of locating a target object in a ranging device of the invention. As shown in FIG. 11, the ranging device 100 can receive a signal transmitted by a signal transmitting module in a target object LRF_TAG_A and accordingly perform the locating operation. The display unit 120 of the ranging device 100 can display the icon RD of the corresponding ranging device 100, and display the corresponding icon TA and the target object distance according to the relative position of the target object LRF_TAG_A, as shown in FIG. 12.

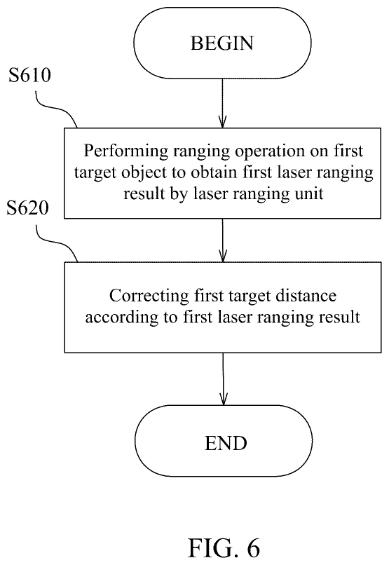

FIG. 6 is a flowchart of an embodiment of a method of correcting a target object distance of the invention. The method of correcting a target distance according to the embodiment of the invention is applicable to the ranging device as shown in FIG. 2. First, in step S610, a laser ranging unit of the ranging device is used to perform a ranging operation on the first target object to obtain a first laser ranging result, and in step S620, the first target distance is corrected according to the first laser ranging result. It should be noted that the first target distance is determined based on the device location of the corresponding ranging device and the location information in the first signal.

It must be noted that in some embodiments, when the ranging device receives signals corresponding to a first target object and a second target object at the same time, wherein the first target object is not within the field of view of the laser ranging unit, and the second target object is within the field of view of the laser ranging unit, the laser ranging unit can perform a ranging operation on the second target object within the field of view to obtain a second laser ranging result, and the second laser ranging result can be used to correct the first target distance corresponding to the first target object that is not within the field of view. Since the first target object and the second target object are both transmitted/detected through signals, the signals can be coordinated for correction. It is worth noting that in some embodiments, when the ranging device can receive signals from the corresponding first target object and the second target object at the same time, a second target distance corresponding to the second target object can be determined according to the device location of the ranging device and the location information in the second signal corresponding to the second target object, and the first target distance can be corrected according to the second target distance and/or the second laser ranging result.

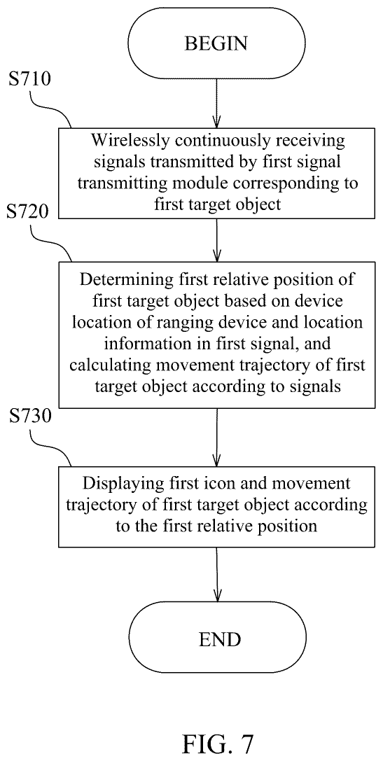

FIG. 7 is a flowchart of another embodiment of a method of locating a target object in a ranging device of the invention. The method of locating a target in a distance measuring device according to the embodiment of the present invention is applicable to the ranging device as shown in FIG. 1 or FIG. 2. In this embodiment, the movement trajectory of the target object can be tracked.

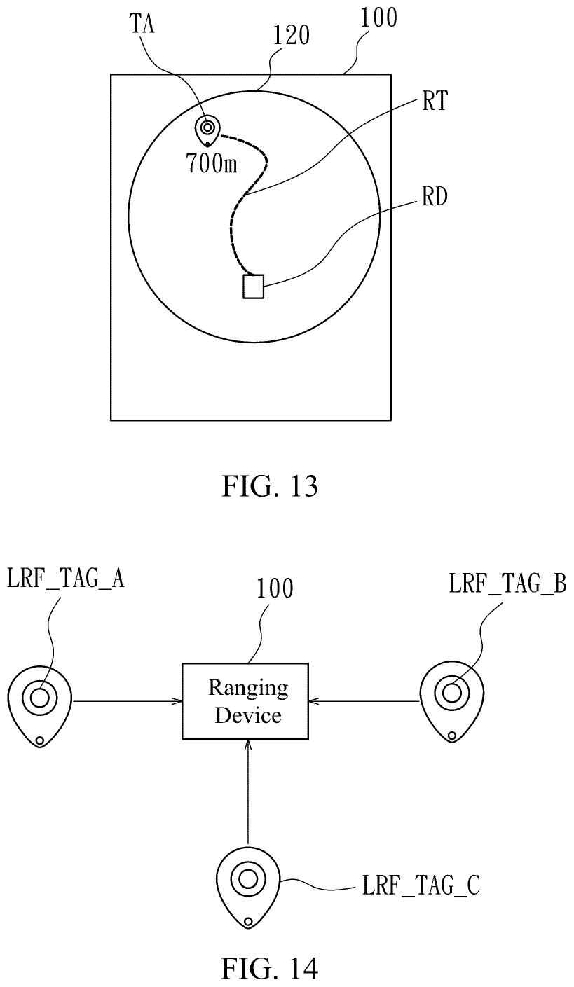

In step S710, the signal receiver of the ranging device is used to wirelessly continuously receive a plurality of signals transmitted by the first signal transmitting module corresponding to the first target object. As mentioned above, the signal transmitting module can be set on a target object and use the GPS technology, the Wi-Fi technology, and/or the UWB positioning technology to send signals with location information. Then, in step S720, a first relative position of the corresponding first target object is determined based on a device location of the corresponding ranging device and the location information in the first signal, and a movement trajectory corresponding to the first target object is calculated according to the signals continuously received from the first target object. Similarly, in some embodiments, the processing unit of the ranging device may also determine the first relative position corresponding to the first target object based on the GPS technology, the Wi-Fi positioning technology, or the UWB positioning technology. Then, in step S730, a display unit of the ranging device is used to display a first icon corresponding to the first target object and the movement trajectory corresponding to the first target object according to the first relative position. Continuing with the example of FIG. 11, when the target object LRF_TAG_A moves and the signals from the target LRF_TAG_A are continuously received, the ranging device 100 can calculate the movement trajectory RT of the target object LRF_TAG_A and display it on the display unit 120, as shown in FIG. 13.

It is noted that, the positioning/tracking target object can be further managed in the present application.

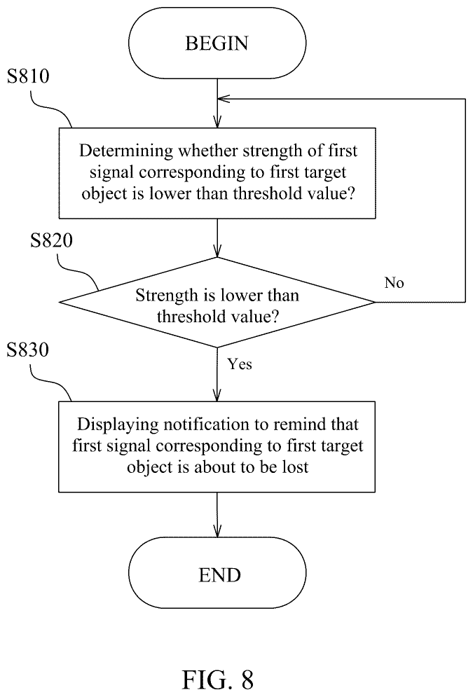

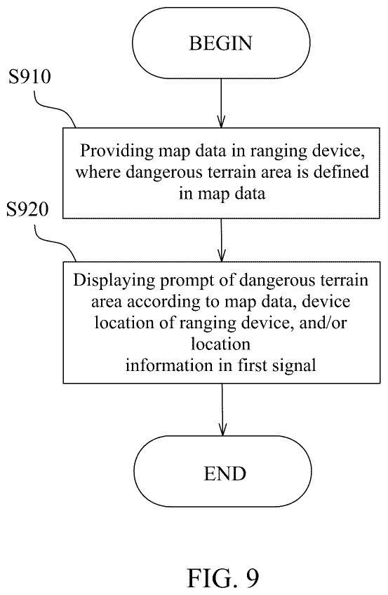

FIG. 8 is a flowchart of another embodiment of a method of locating a target object in a ranging device of the invention. The method of locating a target in a distance measuring device according to the embodiment of the present invention is applicable to the ranging device as shown in FIG. 1 or FIG. 2. In this embodiment, the signal strength of the target object can be further determined and reminded.

In step S810, it is determined whether a strength of a first signal corresponding to a first target object is lower than a threshold value. It should be noted that the threshold value can be adjusted according to different needs and applications, and the invention is not limited to any value. When the strength of the first signal is not lower than the threshold value (No in step S820), the process returns to step S810. When the strength of the first signal is lower than the threshold value (Yes in step S820), in step S830, a notification is displayed on the display unit of the ranging device to remind that the first signal corresponding to the first target object is about to be lost. Through this reminder, the user can react early before losing the first signal of the first target object.

FIG. 8 is a flowchart of another embodiment of a method of locating a target object in a ranging device of the invention. The method of locating a target in a distance measuring device according to the embodiment of the present invention is applicable to the ranging device as shown in FIG. 1 or FIG. 2. In this embodiment, the ranging unit can prompt for dangerous areas in the environment.

In step S910, map data is provided in the ranging device, where at least one dangerous terrain area is defined in the map data. Then, in step S920, the display unit of the ranging device is used to display a prompt corresponding to the dangerous terrain area according to the map data, the device location of the ranging device, and/or the location information in the first signal. Through this reminder, users can prevent themselves or their partners from entering dangerous terrain areas.

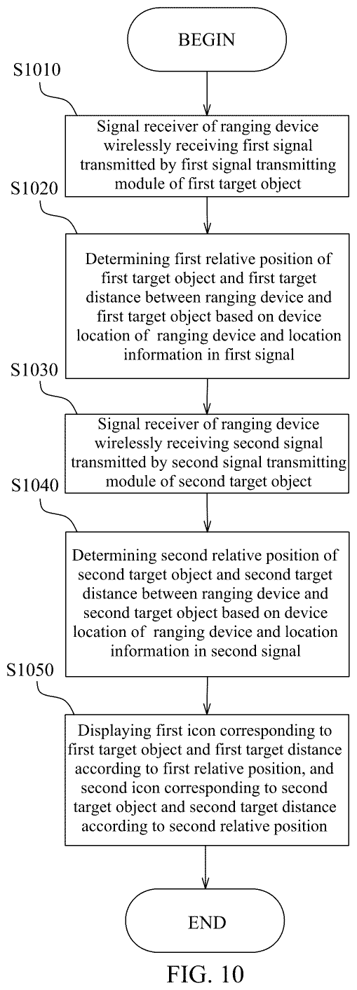

FIG. 10 is a flowchart of another embodiment of a method of locating a target object in a ranging device of the invention. The method of locating a target in a distance measuring device according to the embodiment of the present invention is applicable to the ranging device as shown in FIG. 1 or FIG. 2. In this embodiment, the ranging device can locate multiple target objects simultaneously.

In step S1010, a signal receiver of the ranging device is used to wirelessly receive a first signal transmitted by a first signal transmitting module corresponding to a first target object, and in step S1020, a first relative position of the corresponding first target object and a first target distance between the ranging device and the first target object are determined according to the device location of the ranging device and the location information in the first signal. Similarly, in some embodiments, the processing unit of the ranging device may also determine the first relative position corresponding to the first target object based on the GPS technology, the Wi-Fi positioning technology, or the UWB positioning technology. Then, in step S1030, the signal receiver of the ranging device is used to wirelessly receive a second signal transmitted by a second signal transmitting module corresponding to a second target object, and in step S1040, a second relative position of the corresponding second target object and a second target distance between the ranging device and the second target object are determined according to the device location of the ranging device and the location information in the second signal. Similarly, in some embodiments, the processing unit of the ranging device may also determine the second relative position corresponding to the second target object based on the GPS technology, the Wi-Fi positioning technology, or the UWB positioning technology. In step S1050, a display unit of the ranging device is used to display a first icon corresponding to the first target object and a first target distance corresponding to the first target object according to the first relative position, and display a second icon corresponding to the second target object and a second target distance corresponding to the second target object according to the second relative position.

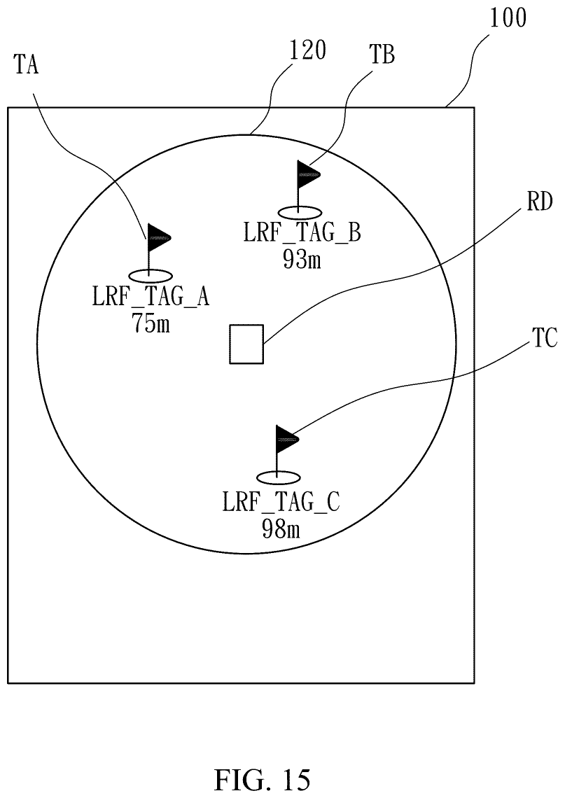

FIG. 14 shows an example of a ranging device locating multiple target objects. As shown in FIG. 14, the ranging device 100 can respectively receive signals from the signal transmitting modules in the target object LRF_TAG_A, the target object LRF_TAG_B, and the target object LRF_TAG_C, and perform the locating operations. The display unit 120 of the ranging device 100 can display the icon RD corresponding to the ranging device 100, and display the icons TA, TB and TC and the target distances respectively corresponding to the target objects LRF_TAG_A, LRF_TAG_B, and LRF_TAG_C according to the relative positions of the target objects LRF_TAG_A, LRF_TAG_B, and LRF_TAG_C, as shown in FIG. 15.

Therefore, the methods of locating a target object in the ranging device and the ranging device thereof of the invention can locate the target object and display the target object in the ranging device, and further perform a ranging operation to increase the accuracy. As mentioned before, in outdoor hunting and golf applications, the functional application of rangefinders is relatively simple and lacks functions such as positioning, finding, and searching. In the present invention, a signal transmitting accessory can be carried on the target person or object, and its location and movement trajectory can be directly positioned and tracked, and shown on the display unit of the ranging device, thereby increasing the convenience when going out hunting or playing golf. In addition, the distance actually measured by the ranging device can be used to correct the estimated distance of the signal transmitting accessory that cannot be actually measured, thereby increasing its accuracy. Furthermore, when positioning and tracking the target object, the present invention can also prompt on the display unit when the target object is about to exceed the connection range, and provide reminders of dangerous terrain areas in the environment.

Methods of locating a target object in a ranging device, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A method of locating a target object in a ranging device for use in a ranging device, comprising:
processing a first signal of a first signal module corresponding to a first target object by a signal processor of the ranging device, wherein the first signal at least comprises location information;
determining a first target distance corresponding to the first target object based on a device location of the ranging device and the location information in the first signal;
performing a ranging operation on the first target object by a laser ranging unit of the ranging device to obtain a first laser ranging result; and
displaying a first icon corresponding to the first target object according to the first target distance or the first laser ranging result through a display unit of the ranging device.

2. The method of claim 1, further comprising:
continuously processing a plurality of signals of the first signal module corresponding to the first target object by the signal processor of the ranging device;
calculating a moving trajectory corresponding to the first target object based on the signals by the ranging device; and
displaying the moving trajectory corresponding to the first target object through the display unit of the ranging device.

3. The method of claim 1, further comprising:
determining whether a strength of the first signal is lower than a threshold value by the ranging device; and
displaying a notification through the display unit of the ranging device to remind that the first signal corresponding to the first target object is about to be lost when the strength of the first signal is lower than the threshold value.

4. The method of claim 1, further comprising:
providing map data in the ranging device, wherein a dangerous terrain area is defined in the map data; and
displaying a prompt corresponding to the dangerous terrain area based on the map data, the device location corresponding to the ranging device, or the location information in the first signal through the display unit of the ranging device.

5. The method of claim 1, further comprising correcting the first target distance based on the first laser ranging result by the ranging device.

6. The method of claim 1, wherein the signal processor determines a first relative position corresponding to the first target object based on a GPS (Global Positioning System) technology, a Wi-Fi positioning technology, or a UWB (Ultra Wideband) positioning technology.

7. The method of claim 1, wherein the signal processor wirelessly receives the first signal transmitted by the first signal module corresponding to the first target object, wherein the technology for receiving or transmitting the first signal is Bluetooth technology or Wi-Fi technology, in which a signal receiver is activated by a signal transmitting module, or the signal transmitting module is activated by the signal receiver.

8. The method of claim 1, further comprising:
processing a second signal corresponding to a second signal module corresponding to a second target object by the signal processor of the ranging device, wherein the second signal at least comprises location information;
determining a second target distance corresponding to the second target object based on the device location of the ranging device and the location information in the second signal;
performing the ranging operation on the second target object to obtain a second laser ranging result by the laser ranging unit of the ranging device; and
correcting the first target distance based on the second target distance or the second laser ranging result by the ranging device.

9. The method of claim 1, further comprising:
processing a second signal corresponding to a second signal module corresponding to a second target object by the signal processor of the ranging device, wherein the second signal at least comprises location information;
determining a second target distance corresponding to the second target object based on the device location of the ranging device and the location information in the second signal; and
displaying a second icon corresponding to the second target object and the corresponding second target distance based on a second relative position through the display unit of the ranging device.

10. The method of claim 1, wherein the display unit comprises a high-resolution dot matrix OLED (Organic Light-Emitting Diode) or a micro OLED.

11. A ranging device, comprising:
a laser ranging unit;
a signal processor processing a first signal of a first signal module corresponding to a first target object, wherein the first signal at least comprises location information;
a display unit; and
a processing unit coupled to the signal processor and the display unit, determining a first target distance corresponding to the first target object based on a device location of the ranging device and the location information in the first signal, performing a ranging operation on the first target object by the laser ranging unit to obtain a first laser ranging result, and displaying a first icon corresponding to the first target object according to the first target distance or the first laser ranging result through the display unit.

12. The ranging device of claim 11, wherein the signal processor further continuously processes a plurality of signals of the first signal module corresponding to the first target object, and the processing unit further calculates a moving trajectory corresponding to the first target object based on the signals, and displays the moving trajectory corresponding to the first target object through the display unit.

13. The ranging device of claim 11, wherein the processing unit further determines whether a strength of the first signal is lower than a threshold value, and displays a notification through the display unit to remind that the first signal corresponding to the first target object is about to be lost when the strength of the first signal is lower than the threshold value.

14. The ranging device of claim 11, wherein the processing unit further obtains map data, wherein a dangerous terrain area is defined in the map data, and displays a prompt corresponding to the dangerous terrain area based on the map data, the device location corresponding to the ranging device, or the location information in the first signal through the display unit.

15. The ranging device of claim 11, wherein the processing unit further corrects the first target distance based on the first laser ranging result.

16. The ranging device of claim 11, wherein the signal processor determines a first relative position corresponding to the first target object based on a GPS (Global Positioning System) technology, a Wi-Fi positioning technology, or a UWB (Ultra Wideband) positioning technology.

17. The ranging device of claim 11, wherein the signal processor wirelessly receives the first signal transmitted by the first signal module corresponding to the first target object, wherein the technology for receiving or transmitting the first signal is Bluetooth technology or Wi-Fi technology, in which a signal receiver is activated by a signal transmitting module, or the signal transmitting module is activated by the signal receiver.

18. The ranging device of claim 11, wherein the signal processor further processes a second signal corresponding to a second signal module corresponding to a second target object, wherein the second signal at least comprises location information, the processing unit further determines a second target distance corresponding to the second target object based on the device location of the ranging device and the location information in the second signal, the laser ranging unit further performs the ranging operation on the second target object to obtain a second laser ranging result, and the processing unit correcting the first target distance based on the second target distance or the second laser ranging result.

19. The ranging device of claim 11, wherein the signal processor further processes a second signal corresponding to a second signal module corresponding to a second target object, wherein the second signal at least comprises location information, and the processing unit determines a second target distance corresponding to the second target object based on the device location of the ranging device and the location information in the second signal, and displays a second icon corresponding to the second target object and the corresponding second target distance based on a second relative position through the display unit.

20. The ranging device of claim 11, wherein the display unit comprises a high-resolution dot matrix OLED (Organic Light-Emitting Diode) or a micro OLED.
